(19) United States
(12) Patent Application Publication
(10) Pub. No.: US 2022/0294624 A1
(43) Pub. Date: Sep. 15, 2022

(54) ENCRYPTION METHOD AND DEVICE, ELECTRONIC APPARATUS AND STORAGE MEDIUM

(71) Applicant: INNOGRIT TECHNOLOGIES CO., LTD., Shanghai (CN)

(72) Inventors: Hui LI, Shanghai (CN); Chuan KE, Shanghai (CN); Zhengtian FENG, Shanghai (CN)

(21) Appl. No.: 17/351,583

(22) Filed: Jun. 18, 2021

(30) Foreign Application Priority Data
Mar. 15, 2021 (CN) 202110276043.2

(51) Int. Cl. H04L 9/08; H04L 9/32; H04L 29/08

(52) U.S. Cl. CPC H04L 9/0891; H04L 9/0863; H04L 9/0894; H04L 9/3226; H04L 67/1097

(57) ABSTRACT

The present disclosure relates to an encryption method and device, an electronic apparatus, and a storage medium. The method comprises: determining whether at least one storage apparatus connected to the terminal apparatus includes a target storage apparatus with an encryption function; acquiring, if the storage apparatus includes the target storage apparatus, encryption information of the target storage apparatus; and generating, if the encryption status is unencrypted, a password setting instruction in response to setting a password, and sending the password setting instruction to the target storage apparatus. According to the encryption method of the embodiment of the present disclosure, the terminal apparatus can be used to determine the encryption information of the storage apparatus, and to set a password, so that the storage apparatus encrypts the data stored in its private partition based on the password. The encryption is executed by the storage apparatus without occupying the processing resources of the terminal apparatus. Besides, the shared partition is not required to be encrypted. Therefore, when accessing the data stored in the shared partition, there is no need to enter a password, which improves the convenience of operation.

### TECHNICAL FIELD

The present disclosure relates to the technical field of computers, and in particular to an encryption method and device, an electronic apparatus, and a storage medium.

### BACKGROUND

Portable storage apparatus (e.g., a portable hard disk, a portable solid state disk, etc.) has the advantages of small volume, portability, large capacity, compatibility with a plurality of terminal apparatuses (e.g., a mobile phone, a tablet, a computer, etc.), quick access, and the like. Portable as it is, it may be easy to lose the portable storage apparatus. As a result, there may be a risk of data leakage.

In the related art, data can often be encrypted to prevent data leakage. For example, computer software may be used to encrypt the files in a portable storage apparatus, a full disk encryption may be performed at the portable storage apparatus, or an additional password lock (e.g., a fingerprint lock, etc.) may be used for encryption.

Nevertheless, use of the computer software to encrypt the files in the portable storage apparatus will occupy the memory and processing resources of a computer. In particular, when a mobile apparatus (for example, a mobile phone) executes a computer software program to encrypt the files, the performance of the mobile apparatus will be seriously affected. When full disk encryption is performed at the portable storage apparatus, the space of the portable storage apparatus cannot be partitioned. Especially when the portable storage apparatus has a large storage space of which a portion may be used to store some data that may not require encryption, the data may require to be decrypted before accessing it, which may degrade convenience of operation. In addition, the encryption with an additional password lock may need an additional apparatus such as a fingerprint identification apparatus, which will increase costs.

### SUMMARY

The present disclosure proposes an encryption method and device, an electronic apparatus, and a storage medium.

According to one aspect of the present disclosure, there is provided an encryption method applicable to a terminal apparatus, the method comprising: determining whether at least one storage apparatus connected to the terminal apparatus includes a target storage apparatus with an encryption function; acquiring, if the at least one storage apparatus includes the target storage apparatus, encryption information of the target storage apparatus, wherein the encryption information includes partition information of the target storage apparatus and an encryption status of a private partition, and the partition information includes an address of a shared partition in the target storage apparatus and an address of the private partition; and generating, if the encryption status is unencrypted, a password setting instruction in response to setting a password, and sending the password setting instruction to the target storage apparatus, such that the target storage apparatus encrypts data stored in the private partition in accordance with the password.

In a possible implementation, determining whether the at least one storage apparatus connected to the terminal apparatus includes the at least one target storage apparatus with the encryption function comprises: generating an apparatus information querying instruction for the target storage apparatus with the encryption function; sending the apparatus information querying instruction to the at least one storage apparatus; and determining, in a case of receiving apparatus information corresponding to the apparatus information querying instruction, that the storage apparatus includes the target storage apparatus, and determining the storage apparatus sending the apparatus information as the target storage apparatus.

In a possible implementation, acquiring, if the storage apparatus includes the target storage apparatus, the encryption information of the target storage apparatus comprises: scanning the target storage apparatus to obtain the partition information of the target storage apparatus; sending the partition information to the target storage apparatus; and receiving the encryption information from the target storage apparatus.

In a possible implementation, the method further comprises: displaying a first interface for receiving a password input if the encryption status is encrypted; and sending, in response to receiving a first password in the first interface, the first password to the target storage apparatus, such that the target storage apparatus verifies the first password.

In a possible implementation, the method further comprises: executing, in a case of receiving a verification success message from the target storage apparatus, at least one of the following operations: reading the data stored in the private partition; writing data into the private partition; deleting the data stored in the private partition; formatting the private partition; and changing a password of the private partition.

According to one aspect of the present disclosure, there is provided an encryption method applicable to a controller of a storage apparatus, the method comprising: determining, in response to the storage apparatus being connected to a terminal apparatus, an encryption status of a private partition in the storage apparatus; generating, in a case of receiving partition information from the terminal apparatus, encryption information in accordance with the partition information and the encryption status, wherein the encryption information includes the partition information of the storage apparatus and the encryption status of the private partition, and the partition information includes an address of a shared partition in the storage apparatus and an address of the private partition; sending the encryption information to the terminal apparatus; and encrypting, in a case of the encryption status being encrypted and a password setting instruction from the terminal apparatus being received, data stored in the private partition in accordance with a second password of the password setting instruction.

In a possible implementation, the method further comprises: sending, in a case of receiving an apparatus information querying instruction from the terminal apparatus, apparatus information of the storage apparatus to the terminal apparatus.

In a possible implementation, the method further comprises: verifying, in a case of the encryption status being encrypted and a third password from the terminal apparatus being received, the third password in accordance with the second password; and sending, in a case of verification success, a verification success message to the terminal apparatus.

In a possible implementation, the method further comprises: decrypting, in a case of receiving a data reading instruction from the terminal apparatus, the encrypted data corresponding to an address in the data reading instruction in accordance with the second password, and sending the decrypted data to the terminal apparatus.

According to one aspect of the present disclosure, there is provided an encryption device provided in a terminal apparatus, the device comprising: a target storage apparatus determining module configured to determine whether at least one storage apparatus connected to the terminal apparatus includes a target storage apparatus with an encryption function; an encryption information acquiring module configured to acquire, if the at least one storage apparatus includes the target storage apparatus, encryption information of the target storage apparatus, wherein the encryption information includes partition information of the target storage apparatus and an encryption status of a private partition, and the partition information includes an address of a shared partition and an address of the private partition in the target storage apparatus; and a password setting module configured to: generate, if the encryption status is unencrypted, a password setting instruction in response to setting a password, and send the password setting instruction to the target storage apparatus, such that the target storage apparatus encrypts data stored in the private partition in accordance with the password.

In a possible implementation, the target storage apparatus determining module is further configured to: generate an apparatus information querying instruction for the target storage apparatus with the encryption function; send the apparatus information querying instruction to the at least one storage apparatus; and determine, in a case of receiving apparatus information corresponding to the apparatus information querying instruction, that the at least one storage apparatus includes the target storage apparatus, and determine the storage apparatus sending the apparatus information as the target storage apparatus.

In a possible implementation, the encryption information acquiring module is further configured to: scan the target storage apparatus to obtain the partition information of the target storage apparatus; send the partition information to the target storage apparatus; and receive encryption information from the target storage apparatus.

In a possible implementation, the device further comprises: a first interface displaying module configured to display a first interface for receiving a password input if the encryption status is encrypted; and a first password transmission module configured to send, in response to receiving a first password in the first interface, the first password to the target storage apparatus, such that the target storage apparatus verifies the first password.

In a possible implementation, the device further comprises: an operation module configured to execute, in a case of receiving a verification success message from the target storage apparatus, at least one of the following operations: reading the data stored in the private partition; writing data into the private partition; deleting the data stored in the private partition; formatting the private partition; and changing a password of the private partition.

According to one aspect of the present disclosure, there is provided an encryption device provided in a controller of a storage apparatus, the device comprising: an encryption status determining module configured to determine, in response to the storage apparatus being connected to a terminal apparatus, an encryption status of a private partition in the storage apparatus; an encryption information generating module configured to generate, in a case of receiving partition information from the terminal apparatus, encryption information in accordance with the partition information and the encryption status, wherein the encryption information includes the partition information of the storage apparatus and the encryption status of the private partition, and the partition information includes an address of a shared partition and an address of the private partition in the storage apparatus; a transmission module configured to send the encryption information to the terminal apparatus; and an encryption module configured to encrypt, in a case of the encryption status being unencrypted and a password setting instruction from the terminal apparatus being received, data stored in the private partition in accordance with a second password of the password setting instruction.

In a possible implementation, the device further comprises: an apparatus information transmission module configured to send, in a case of receiving an apparatus information querying instruction from the terminal apparatus, apparatus information of the storage apparatus to the terminal apparatus.

In a possible implementation, the device further comprises: a verification module configured to verify, in a case of the encryption status being encrypted and a third password from the terminal apparatus being received, the third password in accordance with the second password; and a verification success message transmission module configured to send, in a case of verification success, a verification success message to the terminal apparatus.

In a possible implementation, the device further comprises: a decryption module configured to decrypt, in a case of receiving a data reading instruction from the terminal apparatus, the encrypted data corresponding to an address in the data reading instruction in accordance with the second password, and send the decrypted data to the terminal apparatus.

According to one aspect of the present disclosure, there is provided an electronic apparatus, comprising: a processor; and a memory configured to store processor-executable instructions, wherein the processor is configured to invoke instructions stored in the memory to execute the above-mentioned method.

According to one aspect of the present disclosure, there is provided a computer readable storage medium having computer program instructions stored thereon, wherein the computer program instructions, when executed by a processor, implement the above-mentioned method.

It should be understandable that the general description above and the following detailed description are merely exemplary and explanatory, instead of restricting the present disclosure. Additional features and aspects of the present disclosure will become apparent from the following detailed description of exemplary embodiments with reference to the attached drawings.

### BRIEF DESCRIPTION OF THE DRAWINGS

The drawings herein, which are incorporated in and constitute part of the specification, may illustrate embodiments in line with the present disclosure and be used to explain the technical solutions of the present disclosure together with the specification.

FIG. 1 shows a flowchart of an encryption method according to an embodiment of the present disclosure.

FIGS. 2A, 2B, and 2C show schematic diagrams for encryption information according to an embodiment of the present disclosure.

FIG. 3 shows a schematic diagram for a verification success message according to an embodiment of the present disclosure.

FIG. 4 shows a flowchart of an encryption method according to an embodiment of the present disclosure.

FIG. 5 shows a schematic diagram for encrypting data in a private partition according to an embodiment of the present disclosure.

FIG. 6 shows a schematic diagram for application of an encryption method according to an embodiment of the present disclosure.

FIG. 7 shows a block diagram for an encryption device according to an embodiment of the present disclosure.

FIG. 8 shows a block diagram for an encryption device according to an embodiment of the present disclosure.

FIG. 9 shows a block diagram for an electronic apparatus according to an embodiment of the present disclosure.

FIG. 10 shows a block diagram for an electronic apparatus according to an embodiment of the present disclosure.

### DETAILED DESCRIPTION

Various exemplary embodiments, features and aspects of the present disclosure will be described in detail with reference to the drawings. The same reference numerals in the drawings represent parts having the same or similar functions. Although various aspects of the embodiments are shown in the drawings, it is unnecessary to proportionally draw the drawings unless otherwise specified.

Herein the specific term “exemplary” means “used as an example, or embodiment, or explanatory”. An “exemplary” embodiment given here is not necessarily construed as being superior to or better than other embodiments.

The term “and/or” used herein represents only an association relationship for describing associated objects, and represents three possible relationships. For example, A and/or B may represent the following three cases: A exists alone, both A and B exist, and B exists alone. In addition, the term “at least one” used herein indicates any one of multiple listed items or any combination of at least two of multiple listed items. For example, including at least one of A, B, and C may indicate including any one or more elements selected from the group consisting of A, B, and C.

In addition, numerous details are given in the following specific embodiments for the purpose of better explaining the present disclosure. It should be understood by a person skilled in the art that the present disclosure can still be realized even without some of those details. In some of the examples, methods, means, units and circuits that are well known to a person skilled in the art are not described in detail so that the principle of the present disclosure becomes apparent.

FIG. 1 shows a flowchart of an encryption method according to an embodiment of the present disclosure. As shown in FIG. 1, the encryption method comprises the following steps:

Step S11 of determining whether at least one storage apparatus connected to the terminal apparatus includes a target storage apparatus with an encryption function;

Step S12 of determining, if the at least one storage apparatus includes the target storage apparatus, encryption information of the target storage apparatus, wherein the encryption information includes partition information of the target storage apparatus and an encryption status of a private partition, and the partition information includes an address of a shared partition in the target storage apparatus and an address of the private partition; and

Step S13 of generating, in a case of the encryption status being unencrypted, a password setting instruction in response to setting a password, and sending the password setting instruction to the target storage apparatus, such that the target storage apparatus encrypts data stored in the private partition in accordance with the password.

According to the encryption method of the embodiment of the present disclosure, the terminal apparatus can be used to determine the encryption information of the storage apparatus, and to set a password, so that the storage apparatus encrypts the data stored in its private partition based on the password. The encryption is executed by the storage apparatus without occupying the processing resources of the terminal apparatus. Besides, the data stored in the private partition may be encrypted, while not encrypting the shared partition. Therefore, when accessing the data stored in the shared partition, there is no need to enter a password, which improves the convenience of operation. Further, no additional apparatus is required to encrypt the mobile apparatus, which can save costs.

In a possible implementation, the encryption method may be executed by an electronic apparatus such as a terminal apparatus or a server. The terminal apparatus may be User Equipment (UE), a mobile apparatus, a user terminal, a terminal, a cell phone, a cordless phone, a Personal Digital Assistant (PDA), a handheld apparatus, a computing apparatus, an in-vehicle apparatus, a wearable apparatus, etc. The method may be implemented by invoking, by a processor, the computer readable instructions stored in the memory. Alternatively, the method may be executed by a server.

In a possible implementation, the storage apparatus may include a portable hard disk, a portable solid state disk, a USB flash disk, etc. The present disclosure does not limit the type of the storage apparatus. The storage apparatus may be powered on when connected to the terminal apparatus, that is, it may runs when connected to the terminal apparatus, so that the terminal apparatus can directly access the data stored in the storage apparatus, or access it after decrypting the storage apparatus.

In a possible implementation, the terminal apparatus may be connected to a plurality of storage apparatuses. For example, at least one USB flash disk, at least one portable hard disk, and at least one portable solid state disk can be connected concurrently to a computer. The present disclosure does not limit the number and types of the storage apparatus connected to the terminal apparatus. Those storage apparatuses may include target storage apparatuses with the encryption function. For example, a portable solid state disk may include a controller, which is capable of encrypting all or part of the data (such as the data stored in the preset private partition) in the portable solid state disk.

In a possible implementation, in Step S11, the terminal apparatus may first determine whether the at least one storage apparatus connected thereto includes the target storage apparatus with the encryption function. If the at least one storage apparatus includes the target storage apparatus, the target storage apparatus is selected from the at least one storage apparatus. If the at least one storage apparatus does not include the target storage apparatus, the execution of the encryption method may be ceased.

In a possible implementation, the target storage apparatus can include a controller capable of responding to the instruction from the terminal apparatus, but the other storage apparatuses (e.g., a USB flash disk, etc.) cannot respond to the instruction from the terminal apparatus. As such, in view of the feature that the target storage apparatus includes the controller, the terminal apparatus can generate a controller-responsive instruction, and send it to all of the storage apparatuses connected thereto, to determine which storage apparatus(es) respond to this instruction. Then the storage apparatus(es) responding to the instruction can be determined as the target storage apparatus(es).

In a possible implementation, Step S11 may comprises: generating an apparatus information querying instruction for the target storage apparatus with the encryption function; sending the apparatus information querying instruction to the at least one storage apparatus; and determining, in a case of receiving the apparatus information corresponding to the apparatus information querying instruction, that the at least one storage apparatus includes the target storage apparatus, and determining the storage apparatus sending the apparatus information as the target storage apparatus.

In a possible implementation, the terminal apparatus can scan all storage apparatuses, for example, generate an apparatus information querying instruction for a target storage apparatus with the encryption function, and send the apparatus information querying instruction to all storage apparatuses connected thereto. In an example, the apparatus information querying instruction can be used to query the apparatus information of the storage apparatus, such as the identification of the storage apparatus, the category of the storage apparatus (for instance, the storage apparatus belongs to the category of portable solid state disks, etc.), the capacity of the storage apparatus, and the like. Only the controller of the target storage apparatus can respond to the apparatus information querying instruction. For example, the controller of the target storage apparatus can send the apparatus information as the response information to the terminal apparatus.

In a possible implementation, when the terminal apparatus receives the above-mentioned apparatus information (i.e., the response information), the sender of the apparatus information can be determined as the target storage apparatus. That is, the storage apparatus that sends the apparatus information may be determined as the target storage apparatus.

In a possible implementation, if the storage apparatuses connected to the terminal apparatus include the target storage apparatus, the data stored in the private partition of the target storage apparatus with the encryption function can be encrypted, or the data stored in the private partition can be accessed after entering the password.

In a possible implementation, the terminal apparatus can first determine whether the data stored in the private partition of the target storage apparatus has been encrypted. If the data has not been encrypted, a password may be set to encrypt the data stored in the private partition. If the data has been encrypted, the data stored in the private partition can be accessed after entering the password.

In a possible implementation, in Step S12, the terminal apparatus can determine the encryption information of the target storage apparatus, wherein the encryption information includes the partition information of the target storage apparatus and an encryption status of a private partition, and the partition information includes an address of a shared partition in the target storage apparatus and an address of the private partition. Step S12 may comprise: scanning the target storage apparatus to obtain the partition information of the target storage apparatus; sending the partition information to the target storage apparatus; and receiving the encryption information from the target storage apparatus.

In a possible implementation, the terminal apparatus can obtain the encryption information of the target storage apparatus step by step. Specifically, the terminal apparatus can firstly scan the target storage apparatus to obtain the partition information, and then determine whether the data stored in the private partition of the target storage apparatus has been encrypted.

In an example, the target storage apparatus can be started when connected to the terminal apparatus, that is, the terminal apparatus can supply power to the target storage apparatus when connected, so as to start the target storage apparatus. After being started, the target storage apparatus can scan the storage space to determine whether the data stored in the private partition has been encrypted. For example, if the password has been stored in the private partition, the data stored in the private partition has been encrypted; otherwise, the data stored in the private partition has not been encrypted. Upon starting, the target storage apparatus immediately detects whether the data has been encrypted, and can protect the encrypted data stored in the private partition immediately when it is started.

In an example, after the target storage apparatus is started, the terminal apparatus can scan the partition information of the target storage apparatus, that is, determine the address of the shared partition (i.e. the partition not required to be encrypted) and the address of the private partition (the partition storing the private data, and required to be encrypted). Further, the partition information can be sent to the target storage apparatus. The target storage apparatus can determine whether the data stored in the address of the private partition has been encrypted to determine the encryption status of the private partition. Also, the target storage apparatus can generate the encryption information based on the encryption status, and send it to the terminal apparatus. The terminal apparatus can obtain the encryption information of the target storage apparatus.

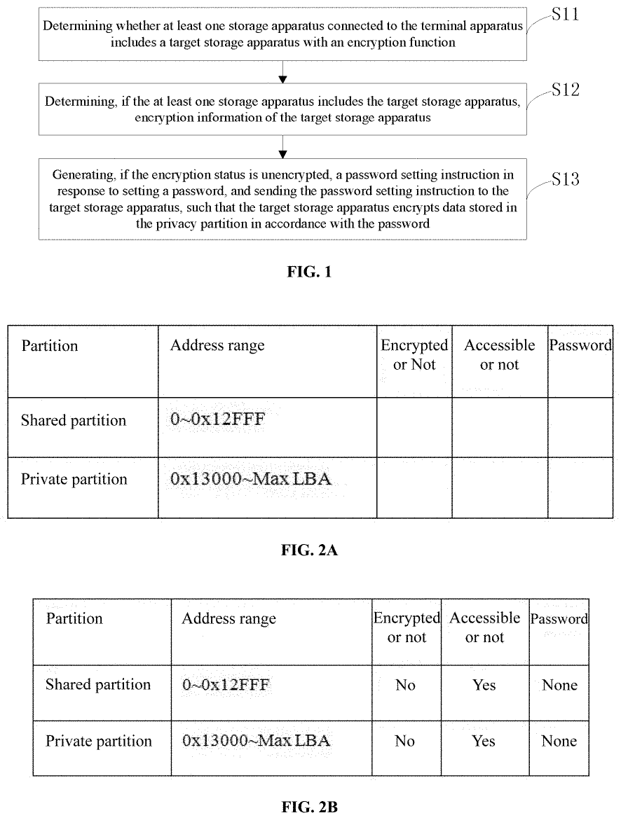

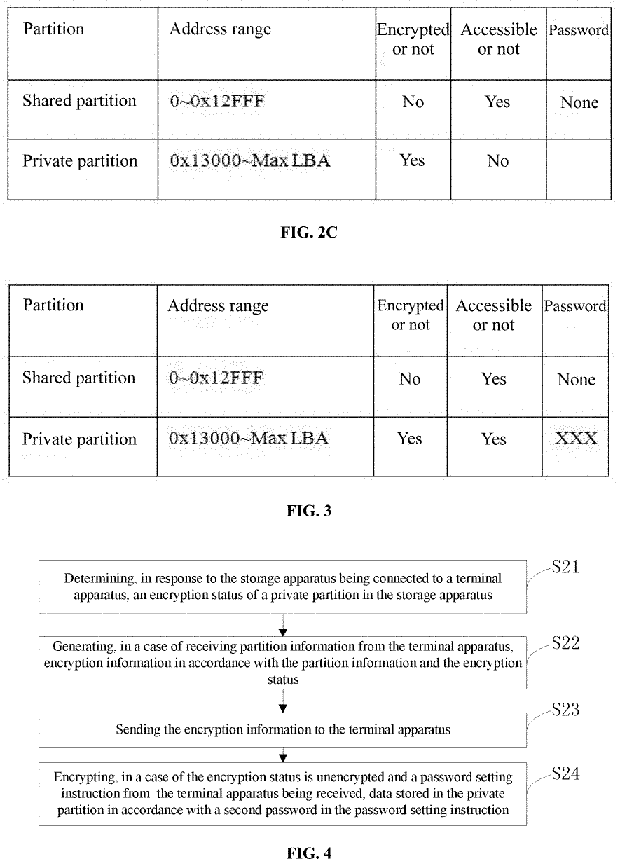

FIGS. 2A, 2B, and 2C show schematic diagrams for encryption information according to an embodiment of the present disclosure. The encryption information may be shown in a table form. In an example, the terminal apparatus can scan the partition information of the target storage apparatus, and can generate a table as shown in FIG. 2A based on the partition information. For example, the table may include a column indicating the address range, i.e., determining the address range of the shared partition and the address range of the private partition. The table may further include a column indicating the encryption status, i.e., determining whether the shared partition is encrypted and the private partition is encrypted. The table may further include a column indicating whether some partition is accessible, i.e., determining whether the shared partition is accessible and the private partition is accessible. The table may further include a password column, i.e., a password for accessing the shared partition and a password for accessing the private partition. After scanning the target storage apparatus to obtain the partition information, the terminal apparatus can write the address range of the shared partition and the address range of the private partition into the table. For example, the address range of the shared partition is in a range from 0 to 0×12FFF, and the address range of the private partition is in a range from 0×13000 to Max LBA (the maximum capacity). The above-mentioned address ranges are only used as examples, but the present disclosure does not limit the address range of each partition. Further, the terminal apparatus can send the table to the target storage apparatus.

In an example, the target storage apparatus, after being started, can determine whether the data stored in the private partition has been encrypted. If the data stored in the private partition has not been encrypted (for example, the target storage apparatus is connected to the terminal apparatus for the first time and no password has been set), the encryption status of the private partition is “No” (unencrypted). The private partition can be accessed randomly before encryption. The private partition does not have a password until a password is set. The target storage apparatus can fill in the table with the above information of the private partition. The shared partition does not need to be encrypted, and can be accessed without entering a password. The target storage apparatus can also fill in the table with the above information of the shared partition. For example, the table as shown in FIG. 2B can be obtained.

In an example, in order to prevent data leakage caused by the loss of the storage apparatus, the user of the target storage apparatus may set a password, and then the encryption status of the private partition is “Yes” (encrypted). If no password is entered or the entered password is erroneous, the private partition will not be accessible. A password field for filling with the password may be blank, and left to be filled in by the user who operates the terminal apparatus. The information of the shared partition remains the same as that when it is not encrypted. Based on the above information, the table as shown in FIG. 2C can be obtained.

In an example, after obtaining the table (i.e., the encryption information) as shown in FIG. 2B or FIG. 2C, the target storage apparatus can send the table to the terminal apparatus. Then the terminal apparatus can obtain the encryption information of the target storage apparatus. If the target storage apparatus has not been encrypted, a password may be set, such that the target storage apparatus may encrypt the data stored in the private partition based on the set password. If the target storage apparatus has been encrypted, the correct password needs to be entered and sent to the target storage apparatus for verification. After the verification succeeds, the data stored in the private partition can be accessed. If no password is entered or the entered password is erroneous, only the data stored in the shared partition can be accessed.

In a possible implementation, if the private partition of the target storage apparatus is not encrypted (for example, the target storage apparatus is connected to the terminal apparatus for the first time), the terminal apparatus can be used to set a password for the private partition of the target storage apparatus, and thus the target storage apparatus can encrypt the data stored in the private partition based on the password.

In an example, if the private partition of the target storage apparatus is not encrypted, the terminal apparatus may display an interface for setting the password, in which the password set by the user can be received. Upon completion of the user input, the terminal apparatus can generate a password setting instruction based on the set password, and send the password setting instruction to the target storage apparatus. The target storage apparatus can encrypt the data stored in the private partition based on the password.

In a possible implementation, after the target storage apparatus encrypts the private partition based on the above-mentioned password, the data stored in the private partition becomes inaccessible, or after power interruption and reconnection to the terminal apparatus, the data becomes inaccessible. That is, the encryption status becomes encrypted. In this context, the user needs to enter the password in the terminal apparatus, and then the entered password is sent to the target storage apparatus by the terminal apparatus. The data stored in the private partition cannot be accessed until the entered password is verified by the target storage apparatus and the verification succeeds.

In a possible implementation, as described above, on the condition that the encryption status of the private partition in the target storage apparatus is encrypted, the user needs to enter the correct password before accessing the data stored in the private partition. The method further comprises: displaying a first interface for receiving password input if the encryption status is encrypted; and sending, in response to receiving a first password in the first interface, the first password to the target storage apparatus, such that the target storage apparatus verifies the first password.

In an example, on the condition that the encryption status of the private partition in the target storage apparatus is encrypted, the terminal apparatus can display the first interface for receiving the password. For example, if the terminal apparatus is a mobile apparatus, the first interface may display content such as a virtual keyboard and an input box, and the user can enter the password in the input box via the virtual keyboard. Alternatively, if the terminal apparatus is a computer, the first interface may display content such as an input box, and the user can enter the password in the input box. After completion of the user input, the terminal apparatus can send the password to the target storage apparatus for verification. For example, the terminal apparatus can fill in the password box of the private partition in the table of FIG. 2C with the first password entered by the user, and send the completed table to the target storage apparatus for verification. After the verification succeeds, the terminal apparatus can receive the verification success message from the target storage apparatus, and the user can access the data stored in the private partition. If the verification fails, the user still cannot access the data stored in the private partition.

FIG. 3 shows a schematic diagram for a verification success message according to an embodiment of the present disclosure. As shown in FIG. 3, after the verification succeeds, the private partition becomes accessible.

In a possible implementation, the method further comprises: executing, in a case of receiving a verification success message from the target storage apparatus, at least one of the following operations: reading the data stored in the private partition; writing data into the private partition; deleting the data stored in the private partition; formatting the private partition; and changing a password of the private partition.

In an example, if the entered first password is correct, the target storage apparatus allows the verification to pass, and the data stored in the private partition can be accessed. In an example, the user can read the data stored in the private partition with the terminal apparatus, for example, can directly view the data stored in the private partition, or copy the data stored in the private partition into the terminal apparatus for view, etc. In an example, the user can write data into the private partition. For example, if the storage space of the private partition is not filled up, the user can write the data stored in the terminal apparatus into the private partition for storage, and can encrypt the data to prevent the data leakage. In an example, the user can delete the data from the private partition with the terminal apparatus. For example, if some data is no longer necessary or private, the user can delete the data for the purpose of saving the storage space of the private partition. In an example, the user can format the private partition with the terminal apparatus. For example, if all data stored in the private partition is no longer necessary or private, the user can format the private partition, and can completely delete all data stored in the privacy space, which not only saves the space, but also removes those data permanently. In an example, the user can change the password of the private partition with the terminal apparatus. For example, in order to further protect the data stored in the private partition, the password may be changed periodically or aperiodically, so that when the target storage apparatus is lost, the password is more difficult to crack, thereby further improving the data security. For example, the terminal apparatus can display a password changing interface for receiving a new password entered by the user, and send the new password to the target storage apparatus. Then the target storage apparatus can re-encrypt the data stored in the private partition based on the new password.

According to the encryption method of the embodiment of the present disclosure, the terminal apparatus can be used to determine the encryption information of the storage apparatus, and to set a password, such that the storage apparatus encrypts the data stored in its private partition based on the password. The encryption is executed by the storage apparatus, without occupying the processing resources of the terminal apparatus. Besides, the data stored in the private partition can be encrypted, while not encrypting the shared partition. When accessing the data stored in the shared partition, there is no need to enter a password, which improves the convenience of operation. When accessing the private partition, a password must be entered and verified by the storage apparatus, which does not occupy the processing resources of the terminal apparatus either, thereby improving the data security.

The present disclosure further provides an encryption method applicable to a controller of a storage apparatus. That is, the storage apparatus can interact with the terminal apparatus by this method.

FIG. 4 shows a flowchart of an encryption method according to an embodiment of the present disclosure. As shown in FIG. 4, the encryption method comprises the following steps:

Step S21 of determining, in response to the storage apparatus being connected to a terminal apparatus, an encryption status of a private partition in the storage apparatus;

Step S22 of generating, in a case of receiving partition information from the terminal apparatus, encryption information in accordance with the partition information and the encryption status, wherein the encryption information includes the partition information of the storage apparatus and the encryption status of the private partition, and the partition information includes an address of a shared partition and an address of the private partition in the storage apparatus;

Step S23 of sending the encryption information to the terminal apparatus; and

Step S24 of encrypting, in a case of the encryption status being unencrypted and a password setting instruction from the terminal apparatus being received, data stored in the private partition in accordance with a second password of the password setting instruction.

In a possible implementation, in Step S21, the storage apparatus can be started when connected to the terminal apparatus. After being started, the storage apparatus can scan the storage space to determine whether the data stored in the private partition has been encrypted. For example, if the password has already been stored in the private partition, the data stored in the private partition has been encrypted. If the password has not been stored in the private partition, the data stored in the private partition has not been encrypted. Once started, the storage apparatus immediately detects whether the data has been encrypted, and initializes units with the encryption function in the controller, so that the data in the encrypted private partition can be protected upon starting. After the units with the encryption function are all started, the other functional units in the controller will be initialized.

In a possible implementation, when the storage apparatus is connected to the terminal apparatus, the terminal apparatus can send the apparatus information querying instruction to the storage apparatus, so as to determine whether the storage apparatus has the encryption function. The method further includes: sending, in a case of receiving an apparatus information querying instruction from the terminal apparatus, apparatus information of the storage apparatus to the terminal apparatus. The apparatus information querying instruction can only be responded by the controller of the storage apparatus with the encryption function, while the storage apparatuses without the encryption function cannot respond to the apparatus information query instruction. The controller of the storage apparatus can send the apparatus information to the terminal apparatus, and the terminal apparatus can determine the storage apparatus as the storage apparatus with the encryption function.

In a possible implementation, the terminal apparatus can scan the partition information of the storage apparatus to create a table as shown in FIG. 2A, and send it to the storage apparatus. In Step S22, the controller of the storage apparatus can determine the encryption status of the private partition when receiving the table as shown in FIG. 2A. For example, the controller determines whether the password has been stored. If the password has been not stored, the encryption status is unencrypted. In this case, the unencrypted status of the private partition can be written into the table to obtain a table as shown in FIG. 2B. If the encryption status is encrypted, the encrypted status of the private partition can be written into the table to obtain a table as shown in FIG. 2C. Further, in Step S23, the encryption information (the table as shown in FIG. 2B or the table as shown in FIG. 2C) can be sent to the terminal apparatus.

In a possible implementation, if the encryption status is unencrypted, the user can set a second password with the terminal apparatus, and generate a password setting instruction based on the second password set by the user, and then send the password setting instruction to the storage apparatus. In Step S24, the controller of the storage apparatus can encrypt the data stored in the private partition according to the second password of the password setting instruction.

In a possible implementation, after the encryption is completed, the controller of the storage apparatus can store the second password for verification, for example, store the second password as the management data of the storage apparatus. The management data is not the user data, and cannot be directly read by the user, which can improve the password security. In an example, the tables as shown in FIGS. 2A, 2B, and 2C, and FIG. 3 may also be the management data of the storage apparatus, and can be used to transfer information between the terminal apparatus and the storage apparatus, but cannot be read directly by the user, which can improve the security of the information in the tables.

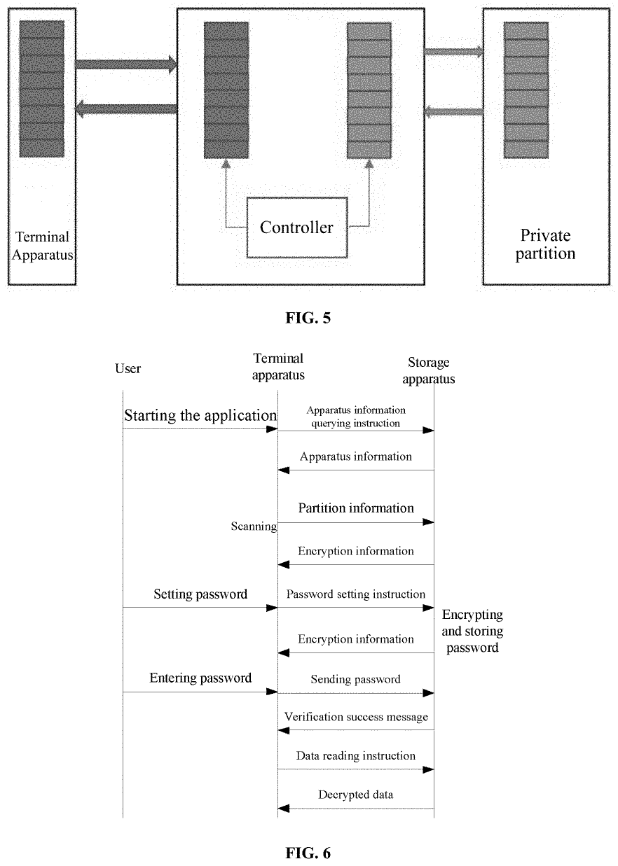

FIG. 5 shows a schematic diagram for encrypting data in a private partition according to an embodiment of the present disclosure. As shown in FIG. 5, the data stored in the shared partition can be directly accessed without decryption or encryption. For example, the data stored in the shared partition can be read and written. For the data stored in the private partition, however, the controller can not only encrypt the private partition to prevent unauthorized access (that is, access without entering the correct password), but also encrypt the data stored in the private partition, that is, encrypt the data itself. In this situation, even if the storage medium of the private partition in the storage apparatus is removed and the storage medium is read directly, the read data is still the encrypted data and cannot be used directly, thereby improving data security. When the terminal apparatus reads the data stored in the private partition, the correct password must be entered. Only if the verification succeeds, can the controller decrypt the data stored in the private partition, so that the terminal apparatus can access the decrypted data.

In a possible implementation, after the above-mentioned encryption process, the encryption status of the private partition is changed to be the encrypted status. If the terminal apparatus sends the table as shown in FIG. 2A, the controller of the storage apparatus can write the encrypted status into the table to obtain a table as shown in FIG. 2C, and send it to the terminal apparatus. When the user accesses, if needed, the data stored in the private partition, the user needs to enter the correct password in the terminal apparatus.

In a possible implementation, the method further comprises: verifying, in a case of the encryption status being encrypted and a third password from the terminal apparatus being received, the third password in accordance with the second password; and sending, in a case of verification success, a verification success message to the terminal apparatus.

In an example, the user enters a third password in the terminal apparatus, and the terminal apparatus can send the third password to the storage apparatus. After receiving the third password, the controller can verify the third password, for example, determine whether the third password is consistent with the second password. If the third password is consistent with the second password, the controller determines that the verification succeeds, and sends a verification success message to the terminal apparatus, so as to allow the terminal apparatus to access the private partition.

In a possible implementation, the method further comprises: decrypting, in a case of receiving a data reading instruction from the terminal apparatus, the encrypted data corresponding to an address in the data reading instruction in accordance with the second password, and sending the decrypted data to the terminal apparatus.

In an example, if the user reads the data stored in the private partition with the terminal apparatus, the terminal apparatus can send a data reading instruction to the storage apparatus, and the controller of the storage apparatus can determine the corresponding data according to the address in the data reading instruction. As the data is in the encrypted status, the data corresponding to the address can be decrypted based on the second password, and after decryption of the data, the terminal apparatus can be allowed to read the data.

In an example, if the verification succeeds, the controller of the storage apparatus may also allow the terminal apparatus to perform at least one of the following operations: writing the data into the private partition, deleting the data stored in the private partition, formatting the private partition, and changing the password of the private partition, and so forth. The present disclosure does not limit the operation of the data stored in the private partition.

According to the encryption method of the embodiment of the present disclosure, the encryption is executed by the storage apparatus, without occupying the processing resources of the terminal apparatus. Besides, the data stored in the private partition can be encrypted to improve the data security, while not encrypting the shared partition. When accessing the data stored in the shared partition, there is no need to enter a password, which improves the convenience of operation. When accessing the private partition, a password must be entered and verified by the storage apparatus, which does not occupy the processing resources of the terminal apparatus either.

FIG. 6 shows a schematic diagram for application of an encryption method according to an embodiment of the present disclosure. As shown in FIG. 6, when the storage apparatus is connected to the terminal apparatus for the first time, the terminal apparatus may access the software installation package in the shared partition of the storage apparatus and install the software package to start an application. The application can generate an apparatus information querying instruction, and send it to the storage apparatus. When connected with the terminal apparatus, the storage apparatus can immediately determine the encryption status of the private partition, so as to immediately protect the data stored in the private partition. The software package is stored in the shared partition for the purpose of: reading the software installation package without entering a password when the terminal apparatus is connected for the first time with the storage apparatus having the encrypted private partition; and installing the software installation package to start the application; and accessing the private partition by entering the password through the application.

In a possible implementation, the storage apparatus with the encryption function can respond to the apparatus information querying instruction, that is, send the apparatus information to the terminal apparatus. The terminal apparatus can determine the storage apparatus making a response as the storage apparatus with the encryption function.

In a possible implementation, the terminal apparatus can scan the storage apparatus to determine the partition information of the storage apparatus, create a table as shown in FIG. 2A, and send it to the storage apparatus. The storage apparatus can write the encryption status into the table. If the storage apparatus is not encrypted, the table as shown in FIG. 2B can be obtained, and the table can be sent as the encryption information to the terminal apparatus.

In a possible implementation, if the storage apparatus is not encrypted, the user can set a password through the terminal apparatus. The terminal apparatus can generate a password setting instruction based on the set password, and send it to the storage apparatus. The controller of the storage apparatus can encrypt the data stored in the private partition based on the password, and store the password in the private partition. After the encryption is performed, the storage apparatus can update the encryption status of the private partition. For example, the table as shown in FIG. 2C can be obtained and sent as the updated encryption information to the terminal apparatus.

In a possible implementation, if the user wants to access the data stored in the private partition after the encryption is performed, the user needs to enter the password in the terminal apparatus, and the terminal apparatus can send the password to the storage apparatus. The storage apparatus can determine whether the password is consistent with the stored password. If the password is consistent with the stored password, the storage apparatus can determine that the verification succeeds and send a verification success message to the terminal apparatus as shown in FIG. 3. After receiving the verification success message, the terminal apparatus can access the data stored in the private partition. For example, the terminal apparatus can read the data stored in the private partition, and can send a data reading instruction to the storage apparatus. The storage apparatus can decrypt the data corresponding to the address in the data reading instruction according to the stored password, and send the decrypted data to the terminal apparatus.

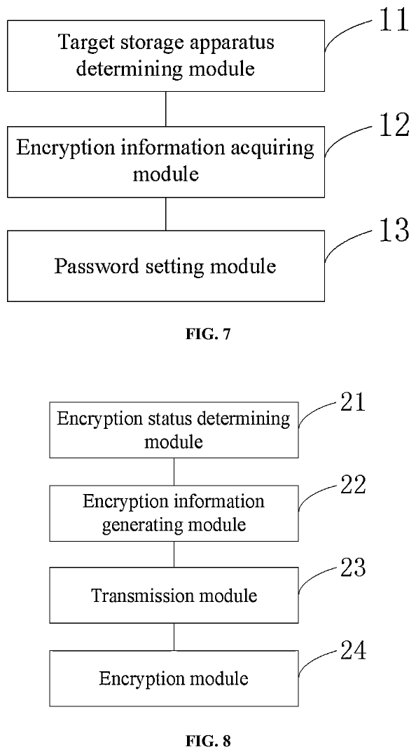

FIG. 7 shows a block diagram for an encryption device according to an embodiment of the present disclosure. As shown in FIG. 7, the device is provided at a terminal apparatus, and comprises: a target storage apparatus determining module 11 configured to determine whether at least one storage apparatus connected to the terminal includes a target storage apparatus with an encryption function; an encryption information acquiring module 12 configured to acquire, if the at least one storage apparatus includes the target storage apparatus, encryption information of the target storage apparatus, wherein the encryption information includes partition information of the target storage apparatus and an encryption status of a private partition, and the partition information includes an address of a shared partition and an address of the private partition in the target storage apparatus; and a password setting module 13 configured to: generate, if the encryption status is unencrypted, a password setting instruction in response to setting a password, and send the password setting instruction to the target storage apparatus, such that the target storage apparatus encrypts data stored in the private partition in accordance with the password.

In a possible implementation, the target storage apparatus determining module is further configured to: generate an apparatus information querying instruction for the target storage apparatus with the encryption function; send the apparatus information querying instruction to the at least one storage apparatus; and determine, in a case of receiving apparatus information corresponding to the apparatus information querying instruction, that the at least one storage apparatus includes the target storage apparatus, and determine the storage apparatus sending the apparatus information as the target storage apparatus.

In a possible implementation, the encryption information acquiring module is further configured to: scan the target storage apparatus to obtain the partition information of the target storage apparatus; send the partition information to the target storage apparatus; and receive encryption information from the target storage apparatus.

In a possible implementation, the device further comprises: a first interface display module configured to display a first interface for receiving a password input if the encryption status is encrypted; and a first password transmission module configured to send, in response to receiving a first password in the first interface, the first password to the target storage apparatus, such that the target storage apparatus verifies the first password.

In a possible implementation, the device further comprises: an operation module configured to execute, in a case of receiving a verification success message from the target storage apparatus, at least one of the following operations: reading the data stored in the private partition; writing data into the private partition; deleting the data stored in the private partition; formatting the private partition; and changing a password of the private partition.

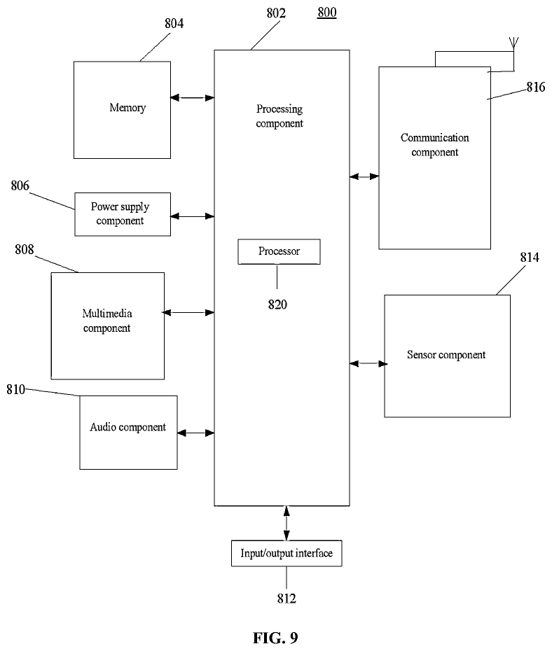

FIG. 8 shows a block diagram for an encryption device according to an embodiment of the present disclosure. As shown in FIG. 8, the device provided at a controller of a storage apparatus comprises: an encryption status determining module 21 configured to determine, in response to the storage apparatus being connected to a terminal apparatus, an encryption status of a private partition in the storage apparatus; an encryption information generating module 22 configured to generate, in a case of receiving partition information from the terminal apparatus, encryption information in accordance with the partition information and the encryption status, wherein the encryption information includes the partition information of the storage apparatus and the encryption status of the private partition, and the partition information includes an address of a shared partition and an address of the private partition in the storage apparatus; a transmission module 23 configured to send the encryption information to the terminal apparatus; and an encryption module 24 configured to encrypt, in a case of the encryption status being unencrypted and a password setting instruction from the terminal apparatus being received, data stored in the private partition in accordance with a second password in the password setting instruction.

In a possible implementation, the device further comprises: an apparatus information transmission module configured to send, in a case of receiving an apparatus information querying instruction from the terminal apparatus, apparatus information of the storage apparatus to the terminal apparatus.

In a possible implementation, the device further comprises: a verification module configured to verify, in a case of the encryption status being encrypted and a third password from the terminal apparatus being received, the third password in accordance with the second password; and a verification success message transmission module configured to send, in a case of verification success, a verification success message to the terminal apparatus.

In a possible implementation, the device further comprises: a decryption module configured to decrypt, in a case of receiving a data reading instruction from the terminal apparatus, the encrypted data corresponding to an address in the data reading instruction in accordance with the second password, and sending the decrypted data to the terminal apparatus.

It is understandable that the above-mentioned method embodiments of the present disclosure may be combined with one another to form a combined embodiment without departing from the principle and the logics, which, due to limited space, will not be repeatedly described in the present disclosure. A person skilled in the art may understand that, in the foregoing method according to specific embodiments, a specific order of execution of the steps should depend on the functions and possible inherent logics of the steps.

In addition, the present disclosure further provides an encryption device, an electronic apparatus, a computer readable storage medium, and a program, which are all capable of realizing any one of the encryption methods provided in the present disclosure. For the corresponding technical solution and descriptions which will not be repeated, reference may be made to the corresponding descriptions of the method.

In some embodiments, functions of or modules included in the device provided in the embodiments of the present disclosure may be configured to execute the method described in the foregoing method embodiments. For specific implementation of the functions or modules, reference may be made to descriptions of the foregoing method embodiments. For brevity, details are not described here again.

The embodiments of the present disclosure further propose a computer readable storage medium having computer program instructions stored thereon, wherein the computer program instructions, when executed by a processor, implement the above-mentioned method. The computer readable storage medium may be a non-volatile computer readable storage medium.

The embodiments of the present disclosure further propose an electronic apparatus, comprising: a processor; and a memory configured to store processor-executable instructions, wherein the processor is configured to execute the above-mentioned method.

The embodiments of the present disclosure further provide a computer program product, comprising a computer readable code, wherein when the computer readable code runs in an apparatus, a processor of the apparatus is configured to implement instructions for the encryption method provided in any one of the above-mentioned embodiments.

The embodiments of the present disclosure further provide another computer program product, configured to store computer readable instructions, which, when executed, cause a computer to execute operations of the encryption method provided in any one of the above-mentioned embodiments.

The electronic apparatus may be provided as a terminal, a server, or an apparatus in other forms.

FIG. 9 shows a block diagram for an electronic apparatus 800 according to an embodiment of the present disclosure. For example, the electronic apparatus 800 may be a mobile phone, a computer, a digital broadcasting terminal, a message transceiving apparatus, a game console, a tablet apparatus, medical equipment, fitness equipment, a personal digital assistant, and other terminals.

Referring to FIG. 9, the electronic apparatus 800 may include one or more components of: a processing component 802, a memory 804, a power supply component 806, a multimedia component 808, an audio component 810, Input/Output (I/O) interface 812, a sensor component 814, and a communication component 816.

The processing component 802 is configured usually to control overall operations of the electronic apparatus 800, such as the operations associated with display, telephone calls, data communications, camera operations, and recording operations. The processing component 802 can include one or more processors 820 configured to execute instructions to perform all or part of the steps included in the above-described methods. In addition, the processing component 802 may include one or more modules configured to facilitate the interaction between the processing component 802 and other components. For example, the processing component 802 may include a multimedia module configured to facilitate the interaction between the multimedia component 808 and the processing component 802.

The memory 804 is configured to store various types of data to support the operation of the electronic apparatus 800. Examples of such data include instructions for any applications or methods operated on the electronic apparatus 800, contact data, phonebook data, messages, pictures, video, etc. The memory 804 may be implemented using any type of volatile or non-volatile memory apparatus, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power supply component 806 is configured to provide power to various components of the electronic apparatus 800. The power supply component 806 may include a power management system, one or more power sources, and any other components associated with the generation, management, and distribution of power in the electronic apparatus 800.

The multimedia component 808 includes a screen providing an output interface between the electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, the multimedia component 808 may include a front camera and/or a rear camera. The front camera and/or the rear camera may receive an external multimedia datum while the electronic apparatus 800 is in an operation mode, such as a photographing mode or a video mode. Either of the front camera and the rear camera may be a fixed optical lens system or may have focus and/or optical zoom capabilities.

The audio component 810 is configured to output and/or input audio signals. For example, the audio component 810 may include a microphone (MIC) configured to receive an external audio signal when the electronic apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output audio signals.

The I/O interface 812 is configured to provide an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors configured to provide status assessments of various aspects of the electronic apparatus 800. For example, the sensor component 814 may detect at least one of an open/closed status of the electronic apparatus 800, relative positioning of components, e.g., the components being the display and the keypad of the electronic apparatus 800. The sensor component 814 may further detect a change of position of the electronic apparatus 800 or its one component, presence or absence of contact between the user and the electronic apparatus 800, location or acceleration/deceleration of the electronic apparatus 800, and a change of temperature of the electronic apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic apparatus 800 and other apparatus. The electronic apparatus 800 can access a wireless network based on a communication standard, such as WiFi, 2G, or 3G, or a combination thereof In an exemplary embodiment, the communication component 816 receives a broadcast signal or broadcast associated information from an external broadcast management system via a broadcast channel. In an exemplary embodiment, the communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-volatile computer readable storage medium including computer program instructions, such as those included in the memory 804, executable by the processor 820 of the electronic apparatus 800, for completing the above-described methods.

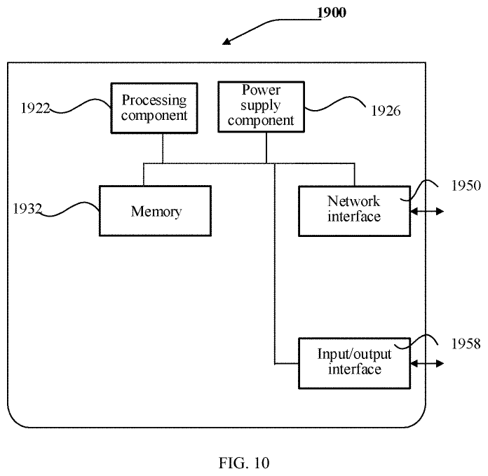

FIG. 10 is another block diagram showing an electronic apparatus 1900 according to an embodiment of the present disclosure. For example, the electronic apparatus 1900 may be provided as a server. Referring to FIG. 10, the electronic apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the above-mentioned methods.

The electronic apparatus 1900 may further include a power supply component 1926 configured to execute power management of the electronic apparatus 1900, a wired or wireless network interface 1950 configured to connect the electronic apparatus 1900 to a network, an Input/Output (I/O) interface 1958. The electronic apparatus 1900 may be operated on the basis of an operating system stored in the memory 1932, such as Windows Server™, Mac OS X™, Unix™, Linux™ or FreeBSD™.

In exemplary embodiments, there is also provided a nonvolatile computer readable storage medium, for example, memory 1932 including computer program instructions, which are executable by the processing component 1922 of the electronic apparatus 1900, to complete the above-described methods.

The present disclosure may be directed to a system, a method, and/or a computer program product. The computer program product may include a computer readable storage medium having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage apparatus, a magnetic storage apparatus, an optical storage apparatus, an electromagnetic storage apparatus, a semiconductor storage apparatus, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded apparatus such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing apparatuses from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing apparatus receives computer readable program instructions from the network and forwards the computer readable program instructions for storage in a computer readable storage medium within the respective computing/processing apparatus.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowcharts and/or block diagrams of methods, apparatus (systems), and computer program products according to embodiments of the present disclosure. It will be appreciated that each block of the flowcharts and/or block diagrams, and combinations of blocks in the flowcharts and/or block diagrams, can be implemented by computer readable program instructions.

These computer readable program instructions may be provided to a processor of a general purpose computer, a special purpose computer, or other programmable data processing devices to produce a machine, such that the instructions, which are executed via the processor of the computer or other programmable data processing devices, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing devices, or other apparatuses to cause a series of operational steps to be performed on the computer, other programmable devices or other apparatuses to produce a computer implemented process, such that the instructions which are executed on the computer, other programmable devices, or other apparatuses implement the functions/acts specified in the flowchart and/or block diagram block or blocks.

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of instruction, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

The computer program product may specifically be implemented by hardware, software, or a combination thereof. In an optional embodiment, the computer program product is specifically embodied as a computer storage medium. In another optional embodiment, the computer program product is specifically embodied as a software product, e.g., a Software Development Kit (SDK) and so forth.

Although the embodiments of the present disclosure have been described above, the foregoing descriptions are exemplary but not exhaustive, and the disclosed embodiments are not limiting. For a person skilled in the art, a number of modifications and variations are obvious without departing from the scope and spirit of the described embodiments. The terms used herein are intended to provide the best explanations on the principles of the embodiments, practical applications, or technical improvements to the technologies in the market, or to make the embodiments described herein understandable to other persons skilled in the art.

1. An encryption method applicable to a terminal apparatus, the method comprising:
determining whether at least one storage apparatus connected to the terminal apparatus includes a target storage apparatus with an encryption function;
acquiring, if the at least one storage apparatus includes the target storage apparatus, encryption information of the target storage apparatus, wherein the encryption information includes partition information of the target storage apparatus and an encryption status of a private partition, and the partition information includes an address of a shared partition in the target storage apparatus and an address of the private partition; and
generating, if the encryption status is unencrypted, a password setting instruction in response to setting a password, and sending the password setting instruction to the target storage apparatus, such that the target storage apparatus encrypts data stored in the private partition in accordance with the password.

2. The method according to claim 1, wherein determining whether the at least one storage apparatus connected to the terminal apparatus includes the target storage apparatus with the encryption function comprises:
generating an apparatus information querying instruction for the target storage apparatus with the encryption function;
sending the apparatus information querying instruction to the at least one storage apparatus; and
determining, in a case of receiving apparatus information corresponding to the apparatus information querying instruction, that the storage apparatus includes the target storage apparatus, and determining the storage apparatus sending the apparatus information as the target storage apparatus.

3. The method according to claim 1, wherein acquiring, if the at least one storage apparatus includes the target storage apparatus, the encryption information of the target storage apparatus comprises:
scanning the target storage apparatus to obtain the partition information of the target storage apparatus;
sending the partition information to the target storage apparatus; and
receiving the encryption information from the target storage apparatus.

4. The method according to claim 1, wherein the method further comprises:
displaying a first interface for receiving a password input if the encryption status is encrypted; and
sending, in response to receiving a first password in the first interface, the first password to the target storage apparatus, such that the target storage apparatus verifies the first password.

5. The method according to claim 4, wherein the method further comprises:
executing, in a case of receiving a verification success message from the target storage apparatus, at least one of the following operations:
reading the data stored in the private partition;
writing data into the private partition;
deleting the data stored in the private partition;
formatting the private partition; or
changing a password of the private partition.

6. An encryption method applicable to a controller of a storage apparatus, the method comprising:
determining, in response to the storage apparatus being connected to a terminal apparatus, an encryption status of a private partition in the storage apparatus;
generating, in a case of receiving partition information from the terminal apparatus, encryption information in accordance with the partition information and the encryption status, wherein the encryption information includes the partition information of the storage apparatus and the encryption status of the private partition, and the partition information includes an address of a shared partition in the storage apparatus and an address of the private partition;
sending the encryption information to the terminal apparatus; and
encrypting, in a case of the encryption status being unencrypted and a password setting instruction from the terminal apparatus being received, data stored in the private partition in accordance with a second password of the password setting instruction.

7. The method according to claim 6, wherein the method further comprises:
sending, in a case of receiving an apparatus information querying instruction from the terminal apparatus, apparatus information of the storage apparatus to the terminal apparatus.

8. The method according to claim 6, wherein the method further comprises:
verifying, in a case of the encryption status being encrypted and a third password from the terminal apparatus being received, the third password in accordance with the second password; and
sending, in a case of verification success, a verification success message to the terminal apparatus.

9. The method according to claim 8, wherein the method further comprises:
decrypting, in a case of receiving a data reading instruction from the terminal apparatus, the encrypted data corresponding to an address in the data reading instruction in accordance with the second password, and sending the decrypted data to the terminal apparatus.

10. An encryption device provided at a terminal apparatus, the device comprising:
a target storage apparatus determining module configured to determine whether at least one storage apparatus connected to the terminal apparatus includes a target storage apparatus with an encryption function;
an encryption information acquiring module configured to acquire, if the storage apparatus includes the target storage apparatus, encryption information of the target storage apparatus, wherein the encryption information includes partition information of the target storage apparatus and an encryption status of a private partition, and the partition information includes an address of a shared partition and an address of the private partition in the target storage apparatus; and
a password setting module configured to: generate, if the encryption status is unencrypted, a password setting instruction in response to setting a password, and send the password setting instruction to the target storage apparatus, such that the target storage apparatus encrypts data stored in the private partition in accordance with the password.

11. An encryption device provided at a controller of a storage apparatus, the device comprising:
an encryption status determining module configured to determine, in response to the storage apparatus being connected to a terminal apparatus, an encryption status of a private partition in the storage apparatus;
an encryption information generating module configured to generate, in a case of receiving partition information from the terminal apparatus, encryption information in accordance with the partition information and the encryption status, wherein the encryption information includes the partition information of the storage apparatus and the encryption status of the private partition, and the partition information includes an address of a shared partition and an address of the private partition in the storage apparatus;
a transmission module configured to send the encryption information to the terminal apparatus; and
an encryption module configured to encrypt, in a case of the encryption status being unencrypted and a password setting instruction from the terminal apparatus being received, data stored in the private partition in accordance with a second password of the password setting instruction.

12. An electronic apparatus, comprising:
a processor; and
a memory configured to store processor-executable instructions,
wherein the processor is configured to execute instructions stored in the memory to perform a method, the method comprising:
determining whether at least one storage apparatus connected to a terminal apparatus includes a target storage apparatus with an encryption function;
acquiring, if the at least one storage apparatus includes the target storage apparatus, encryption information of the target storage apparatus, wherein the encryption information includes partition information of the target storage apparatus and an encryption status of a private partition, and the partition information includes an address of a shared partition in the target storage apparatus and an address of the private partition; and
generating, if the encryption status is unencrypted, a password setting instruction in response to setting a password, and sending the password setting instruction to the target storage apparatus, such that the target storage apparatus encrypts data stored in the private partition in accordance with the password.

13. A non-transitory computer readable storage medium having computer program instructions stored thereon, which when executed by a processor, cause the processor to perform a method, the method comprising:
determining whether at least one storage apparatus connected to a terminal apparatus includes a target storage apparatus with an encryption function;
acquiring, if the at least one storage apparatus includes the target storage apparatus, encryption information of the target storage apparatus, wherein the encryption information includes partition information of the target storage apparatus and an encryption status of a private partition, and the partition information includes an address of a shared partition in the target storage apparatus and an address of the private partition; and
generating, if the encryption status is unencrypted, a password setting instruction in response to setting a password, and sending the password setting instruction to the target storage apparatus, such that the target storage apparatus encrypts data stored in the private partition in accordance with the password.

14. The computer readable storage medium according to claim 13, wherein determining whether the at least one storage apparatus connected to the terminal apparatus includes the target storage apparatus with the encryption function comprises:
generating an apparatus information querying instruction for the target storage apparatus with the encryption function;
sending the apparatus information querying instruction to the at least one storage apparatus; and
determining, in a case of receiving apparatus information corresponding to the apparatus information querying instruction, that the storage apparatus includes the target storage apparatus, and determining the storage apparatus sending the apparatus information as the target storage apparatus.

15. The computer readable storage medium according to claim 13, wherein acquiring, if the at least one storage apparatus includes the target storage apparatus, the encryption information of the target storage apparatus comprises:
scanning the target storage apparatus to obtain the partition information of the target storage apparatus;
sending the partition information to the target storage apparatus; and
receiving the encryption information from the target storage apparatus.

16. The computer readable storage medium according to claim 13, wherein the method further comprises:
displaying a first interface for receiving a password input if the encryption status is encrypted; and
sending, in response to receiving a first password in the first interface, the first password to the target storage apparatus, such that the target storage apparatus verifies the first password.

17. The method according to claim 16, wherein the method further comprises:
executing, in a case of receiving a verification success message from the target storage apparatus, at least one of the following operations:
reading the data stored in the private partition;
writing data into the private partition;
deleting the data stored in the private partition;
formatting the private partition; or
changing a password of the private partition.
